(19) United States
(12) Patent Application Publication
(10) Pub. No.: US 2014/0111416 A1
(43) Pub. Date: Apr. 24, 2014

(54) ELECTRONIC APPARATUS AND HANDWRITTEN DOCUMENT PROCESSING METHOD

(71) Applicant: KABUSHIKI KAISHA TOSHIBA, Tokyo (JP)

(72) Inventor: Chikashi Sugiura, Tokyo (JP)

(73) Assignee: KABUSHIKI KAISHA TOSHIBA, Tokyo (JP)

(21) Appl. No.: 13/763,436

(22) Filed: Feb. 8, 2013

(30) Foreign Application Priority Data
Oct. 23, 2012 (JP) 2012-233587

(51) Int. Cl. G06F 3/03

(52) U.S. Cl. CPC G06F 3/03
USPC 345/156

(57) ABSTRACT

According to one embodiment, an electronic apparatus includes a display processor, a generator and a recognition module. The display processor displays a plurality of strokes with a first line width, the plurality of strokes being input by handwriting. The generator generates a plurality of stroke data corresponding to the plurality of strokes. The recognition module recognizes a character corresponding to one or more strokes of the plurality of strokes using the plurality of stroke data. The display processor displays the one or more strokes with a line width according to a size of the recognized character.

### CROSS-REFERENCE TO RELATED APPLICATIONS

This application is based upon and claims the benefit of priority from Japanese Patent Application No. 2012-233587, filed Oct. 23, 2012, the entire contents of which are incorporated herein by reference.

### FIELD

Embodiments described herein relate generally to processing of a handwritten document.

### BACKGROUND

In recent years, various electronic apparatuses such as tablets, PDAs, and smartphones have been developed. Most of electronic apparatuses of this type include touch screen displays so as to facilitate user's input operations.

When the user touches a menu or object displayed on the touch screen display with the finger or the like, he or she can instruct the electronic apparatus to execute a function associated with the touched menu or object.

Some of such electronic apparatuses have a function of allowing the user to handwrite characters, figures, and the like on the touch screen display. A handwritten document (handwritten page) including such handwritten characters and figures is stored, and is browsed as needed.

When the user handwrites characters and figures on a paper document (paper page) such as a notebook, he or she often changes a color or width (thickness) of a pen to be used. Therefore, even on a document handwritten on the touch screen display, it is expected to change a color or width of a line of a character or figure to be input by handwriting.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the external appearance of an electronic apparatus according to an embodiment.

FIG. 2 is a view showing an example of a handwritten document to be processed by the electronic apparatus of the embodiment.

FIG. 3 is an exemplary view for explaining time-series information corresponds to the handwritten document shown in FIG. 2, the time-series information being stored in a storage medium by the electronic apparatus of the embodiment.

FIG. 4 is a block diagram showing the system configuration of the electronic apparatus of the embodiment.

FIG. 5 is an exemplary block diagram showing the functional configuration of a digital notebook application program executed by the electronic apparatus of the embodiment.

FIG. 6 is a view showing a change example of a line width of handwritten characters by the electronic apparatus of the embodiment.

FIG. 7 is a view showing a recognition example of handwritten characters by the electronic apparatus of the embodiment.

FIG. 8 is shows a configuration example of line width data used by the electronic apparatus of the embodiment.

FIG. 9 is a flowchart showing an example of the procedure of handwriting input processing executed by the electronic apparatus of the embodiment.

### DETAILED DESCRIPTION

Various embodiments will be described hereinafter with reference to the accompanying drawings.

In general, according to one embodiment, an electronic apparatus includes a display processor, a generator and a recognition module. The display processor is configured to display a plurality of strokes with a first line width, the plurality of strokes being input by handwriting. The generator is configured to generate a plurality of stroke data corresponding to the plurality of strokes. The recognition module is configured to recognize a character corresponding to one or more strokes of the plurality of strokes using the plurality of stroke data. The display processor is configured to display the one or more strokes with a line width according to a size of the recognized character.

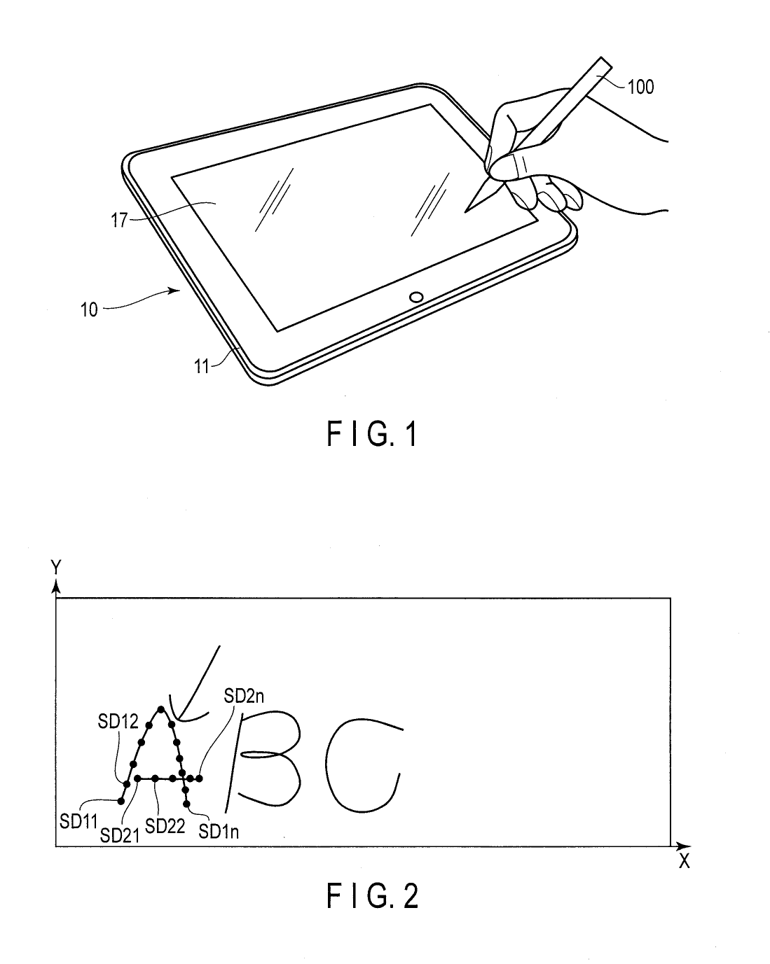

FIG. 1 is a perspective view showing the external appearance of an electronic apparatus according to one embodiment. This electronic apparatus is, for example, a pen-based portable electronic apparatus which allows a handwriting input using a pen or the finger. This electronic apparatus can be implemented as a tablet computer, notebook-type personal computer, smartphone, PDA, and the like. The following description will be given under the assumption that this electronic apparatus is implemented as a tablet computer 10. The tablet computer 10 is a portable electronic apparatus which is also called a tablet or slate computer, and includes a main body 11 and touch screen display 17, as shown in FIG. 1. The touch screen display 17 is attached to be overlaid on the upper surface of the main body 11.

The main body 11 has a thin box-shaped housing. The touch panel screen 17 incorporates a flat panel display and a sensor which is configured to detect a touch position of a pen or finger on the screen of the flat panel display. The flat panel display may be, for example, a liquid crystal display (LCD). As the sensor, for example, a touch panel of a capacitance type, a digitizer of an electromagnetic induction type, or the like can be used. The following description will be given under the assumption that both the two types of sensors, that is, the digitizer and touch panel are incorporated in the touch screen display 17.

Each of the digitizer and touch panel is arranged to cover the screen of the flat panel display. This touch screen display 17 can detect not only a touch operation on the screen using the finger but also that on the screen using a pen 100. The pen 100 may be, for example, an electromagnetic induction pen.

The user can make a handwriting input operation on the touch screen display 17 using an external object (pen 100 or finger). During the handwriting input operation, a path of movement of the external object (pen 100 or finger), that is, a path (handwriting) of a stroke handwritten by the handwriting input operation on the screen is drawn in real-time, thereby displaying the path of each stroke on the screen. The path of the movement of the external object while the external object is in contact with the screen corresponds to one stroke. Sets of a large number of strokes corresponding to a handwritten character or figure, that is, a number of sets of paths (handwriting) configure a handwritten document.

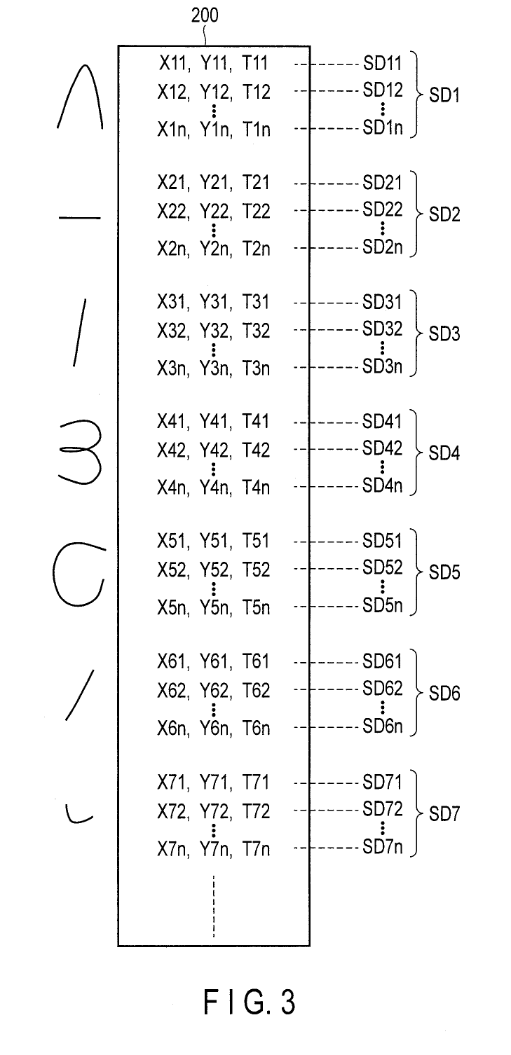

In this embodiment, this handwritten document is stored in a storage medium not as image data but as handwritten document data including coordinate sequences of paths of respective strokes and time-series information indicative of an order relation between strokes. Details of this time-series information will be described in detail later with reference to FIG. 3. This time-series information generally means a set of time-series stroke data corresponding to a plurality of strokes. Each stroke data corresponds to one stroke, and includes a coordinate data sequence (time-series coordinates) corresponding to respective points on a path of this stroke. An arrangement order of these stroke data corresponds to a handwriting order of respective strokes, that is, a stroke order.

The tablet computer 10 can read existing arbitrary handwritten document from the storage medium, and can display, on the screen, a handwritten document corresponding to this handwritten document data. That is, the tablet computer 10 can display a handwritten document on which paths corresponding to a plurality of strokes indicated by time-series information are drawn.

The relationship between strokes (a character, mark, symbol, figure, table, and the like) handwritten by the user and the time-series information will be described below with reference to FIGS. 2 and 3. FIG. 2 shows an example of a handwritten document handwritten on the touch screen display 17 using the pen 100 or the like.

In a handwritten document, still another character, figure, or the like is handwritten above already handwritten characters, figures, or the like. FIG. 2 assumes a case in which a handwritten character string “ABC” is handwritten in an order of “A”, “B”, and “C”, and a handwritten arrow is then handwritten in the vicinity of a handwritten character “A”.

The handwritten character “A” is expressed by two strokes (a path of a “Λ” shape and that of a “-” shape) handwritten using the pen 100 or the like, that is, two paths. The “Λ”-shaped path of the pen 100, which is handwritten first, is sampled in real-time at, for example, equal time intervals, thereby obtaining time-series coordinates SD11, SD12, . . . , SD1n of the “Λ”-shaped stroke. Likewise, the “-”-shaped path of the pen 100, which is handwritten next, is sampled, thereby obtaining time-series coordinates SD21, SD22, . . . , SD2n of a “-”-shaped stroke.

The handwritten character “B” is expressed by two strokes handwritten using the pen 100 or the like, that is, two paths. The handwritten character “C” is expressed by one stroke handwritten using the pen 100 or the like, that is, one path. The handwritten “arrow” is expressed by two strokes handwritten using the pen 100 or the like, that is, two paths.

FIG. 3 shows time-series information 200 corresponding to the handwritten document shown in FIG. 2. The time-series information 200 includes a plurality of stroke data SD1, SD2, . . . , SD7. In the time-series information 200, these stroke data SD1, SD2, . . . , SD7 are time-serially arranged in a stroke order, that is, a handwritten order of a plurality of strokes.

In the time-series information 200, the first and second stroke data SD1 and SD2 respectively indicate two strokes of the handwritten character “A”. The third and fourth stroke data SD3 and SD4 respectively indicate two strokes of the handwritten character “B”. The fifth stroke data SD5 indicates one stroke of the handwritten character “C”. The sixth and seventh stroke data SD6 and SD7 respectively indicate two strokes of the handwritten arrow.

Each stroke data includes a coordinate data sequence (time-series coordinates) corresponding to one stroke, that is, a plurality of coordinates corresponding to a plurality of points on a path of one stroke. In each stroke data, the plurality of coordinates are time-serially arranged in an order that stroke was written. For example, as for the handwritten character “A”, the stroke data SD1 includes a coordinate data sequence (time-series coordinates) corresponding to respective points on the path of the “Λ”-shaped stroke of the handwritten character “A”, that is, n coordinate data SD11, SD12, . . . , SD1n. The stroke data SD2 includes a coordinate data sequence corresponding to respective points on the path of the “-”-shaped stroke of the handwritten character “A”, that is, n coordinate data SD21, SD22, . . . , SD2n. Note that the number of coordinate data may be different for each stroke data.

Each coordinate data indicates X and Y coordinates corresponding to one point in the corresponding path. For example, the coordinate data SD11 indicates an X coordinate (X11) and Y coordinate (Y11) of a start point of the “Λ”-shaped stroke. Also, the coordinate data SD1n indicates an X coordinate (X1n) and Y coordinate (Y1n) of an end point of the “Λ”-shaped stroke.

Furthermore, each coordinate data may include time stamp information T indicative of a handwritten timing of a point corresponding to that coordinate data. The handwritten timing may be either an absolute time (for example, year, month, day, hour, minute, second) or a relative time with reference to a certain timing. For example, an absolute time (for example, year, month, day, hour, minute, second) at which a stroke began to be written may be added to each stroke data as time stamp information, and a relative time indicative of a difference from the absolute time may be added to each coordinate data in that stroke data as the time stamp information T.

In this way, using the time-series information in which the time stamp information T is added to each coordinate data, the temporal relationship between strokes can be precisely expressed.

Information (Z) indicative of a writing pressure may be added to each coordinate data.

Furthermore, in this embodiment, since a handwritten document is stored as the time-series information 200 including sets of time-series stroke data in place of an image or character recognition results, as described above, handwritten characters and figures can be handled independently of languages. Hence, the structure of the time-series information 200 of this embodiment can be commonly used in various countries using different languages around the world.

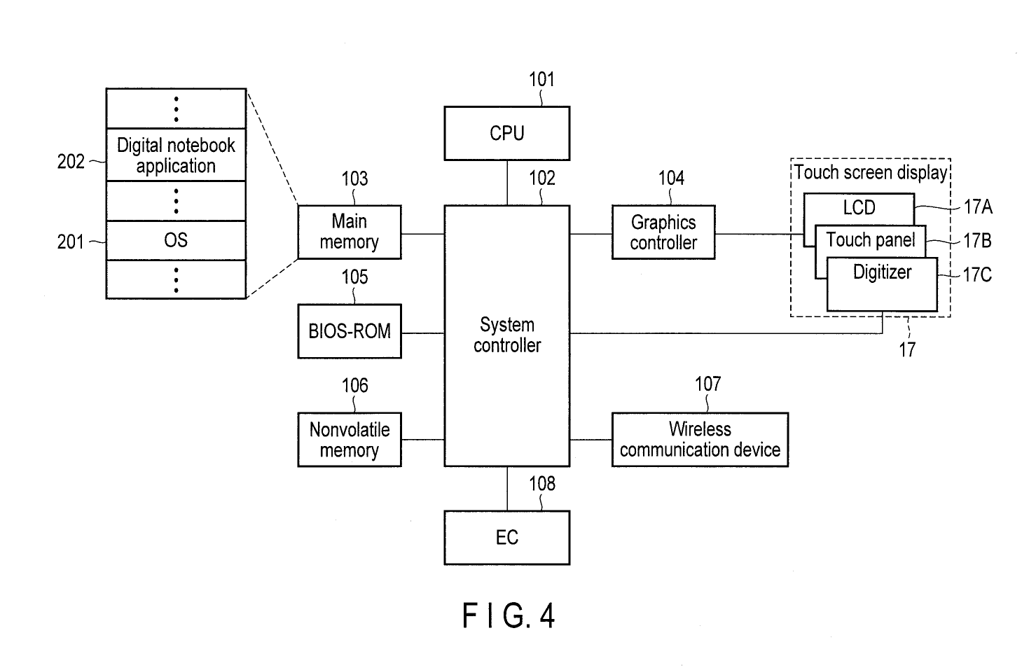

FIG. 4 shows the system configuration of the tablet computer 10.

As shown in FIG. 4, the tablet computer 10 includes a CPU 101, a system controller 102, a main memory 103, a graphics controller 104, a BIOS-ROM 105, a nonvolatile memory 106, a wireless communication device 107, an embedded controller (EC) 108, and the like.

The CPU 101 is a processor, which controls operations of various components in the tablet computer 10. The CPU 101 executes various software programs which are loaded from the nonvolatile memory 106 as a storage device onto the main memory 103. These software programs include an operating system (OS) 201 and various application programs. The application programs include a digital notebook application program 202. This digital notebook application program 202 has a function of creating and displaying the aforementioned handwritten document, a function of controlling a line width of a stroke (path) drawn on a handwritten document, and the like.

The CPU 101 also executes a basic input/output system (BIOS) stored in the BIOS-ROM 105. The BIOS is a program required for hardware control.

The system controller 102 is a device which connects a local bus of the CPU 101 and various components. The system controller 102 also incorporates a memory controller which controls accesses to the main memory 103. The system controller 102 also has a function of executing communications with the graphics controller 104 via, for example, a PCI EXPRESS serial bus.

The graphics controller 104 is a display controller which controls an LCD 17A used as a display monitor of this tablet computer 10. A display signal generated by this graphics controller 104 is sent to the LCD 17A. The LCD 17A displays a screen image based on the display signal. On this LCD 17A, a touch panel 17B and digitizer 17C are arranged. The touch panel 17B is a capacitance type pointing device used to allow the user to make an input on the screen of the LCD 17A. The touch panel 17B detects a touch position of the finger on the screen, a movement of the touch position, and the like. The digitizer 17C is an electromagnetic induction type pointing device used to allow the user to make an input on the screen of the LCD 17A. The digitizer 17C detects a touch position of the pen 100 on the screen, a movement of the touch position, and the like.

The wireless communication device 107 is a device configured to execute wireless communications such as wireless LAN or 3G mobile communications. The EC 108 is a one-chip microcomputer including an embedded controller required for power management. The EC 108 has a function of turning on/off the power supply of this tablet computer 10 in response to an operation of a power button by the user.

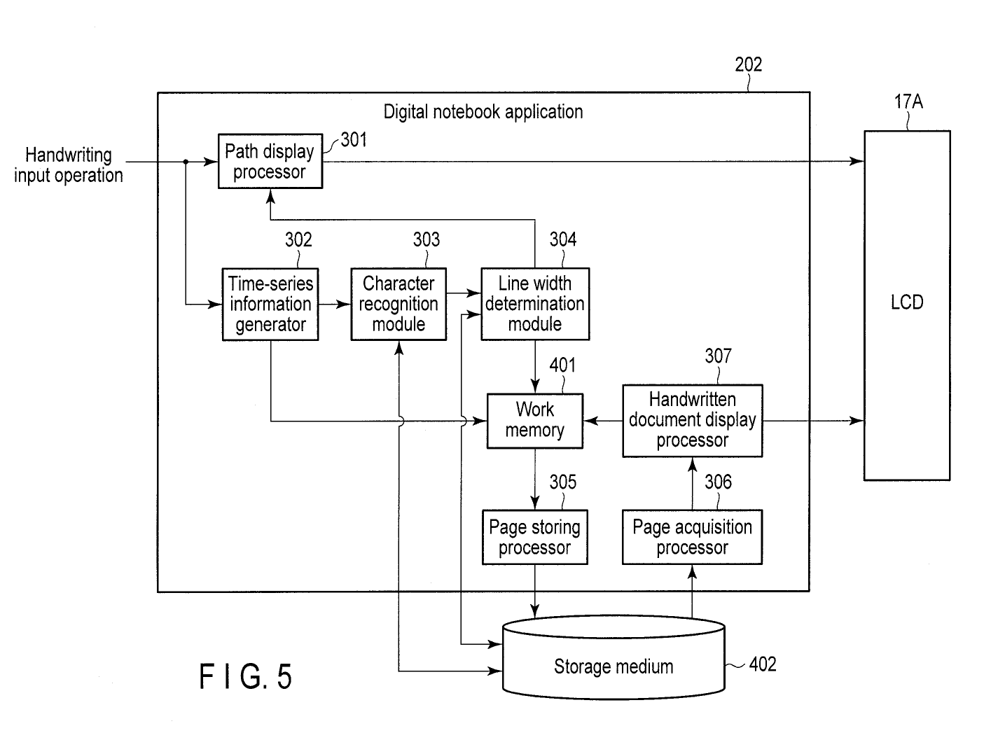

The functional configuration of the digital notebook application program 202 will be described below with reference to FIG. 5.

The digital notebook application program 202 includes, for example, a path display processor 301, a time-series information generator 302, a character recognition module 303, a line width determination module 304, a page storing processor 305, a page acquisition processor 306, a handwritten document display processor 307, and the like.

The touch screen display 17 is configured to generate events “touch”, “move (slide)”, “release”, and the like. The “touch” event indicates that the external object touched on the screen. The “move (slide)” event indicates that a touch position was moved while the external object touched on the screen. The “release” event indicates that the external object was released from the screen.

The path display processor 301 and time-series information generator 302 receive the “touch” or “move (slide)” event generated by the touch screen display 17, thereby detecting a handwriting input operation. The “touch” event includes coordinates of a touch position. The “move (slide)” event includes coordinates of a touch position of a move destination. Therefore, the path display processor 301 and time-series information generator 302 can receive a coordinate sequence corresponding to a path of a movement of a touch position from the touch screen display 17.

The path display processor 301 receives a coordinate sequence from the touch screen display 17, and displays, on the screen of the LCD 17A in the touch screen display 17, a path of each stroke handwritten by a handwriting input operation using the pen 100 or the like based on this coordinate sequence. This path display processor 301 draws a path of the pen 100 while the pen 100 touches on the screen, that is, that of each stroke on the screen of the LCD 17A. The path display processor 301 displays a plurality of strokes (paths) input by handwriting to have a first line width (for example, a line width specified by the application 202, that selected by the user, or the like).

The time-series information generator 302 receives the aforementioned coordinate sequence output from the touch screen display 17. Then, the time-series information generator 302 generates time-series information (a plurality of stroke data corresponding to a plurality of strokes) having the structure described in detail above using FIG. 3 based on this coordinate sequence. In this case, the time-series information, that is, coordinates and time stamp information corresponding to respective points of strokes may be temporarily stored in a work memory 401.

In this embodiment, line widths (line thicknesses) of a plurality of strokes (paths) displayed on the screen are controlled according to sizes of characters corresponding to these strokes. A character size corresponding to strokes may be a size of a character after character recognition processing has been executed or that of a character input by handwriting before the character recognition processing.

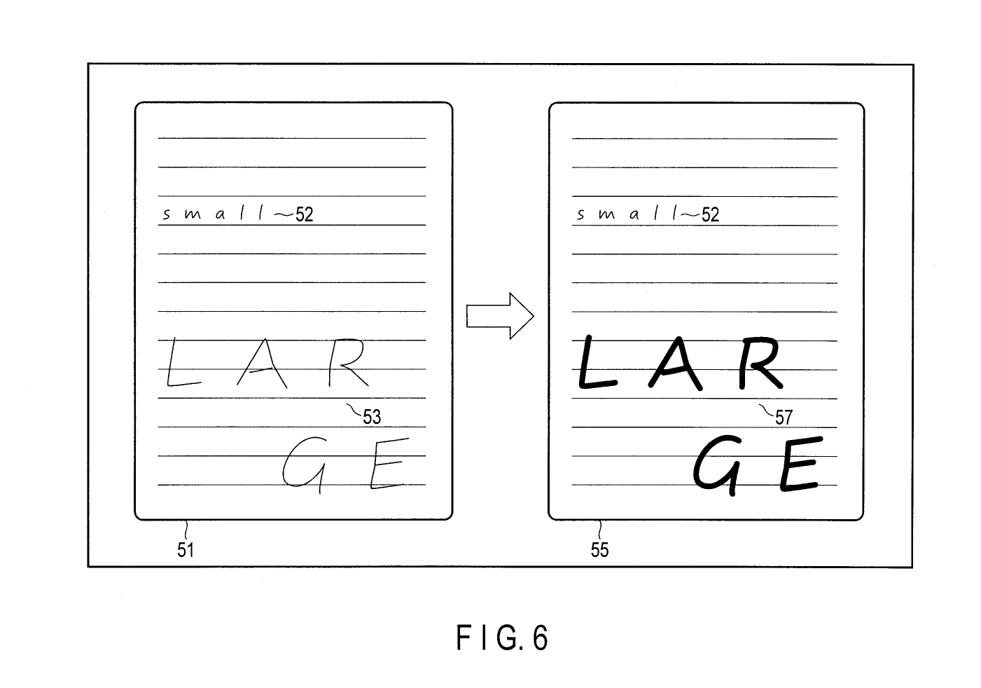

FIG. 6 shows a change example of a line width of handwritten characters. Assume that “small” 52 having a small character size (for example, 10 point) and “LARGE” 53 having a large character size (for example, 30 point) are handwritten on a handwritten document 51.

In this embodiment, as shown in a handwritten document 55, “small” 52 are displayed with a thin line width (for example, 0.75 point) which is equal to that at the time of handwriting input processing, and “LARGE” 57 are displayed by changing their line width to a thick line width (for example, 3 point). In this manner, the characters can be displayed with line widths according to the character sizes without requiring the user to designate a line width at the time of handwriting input processing. For example, when the user handwrites characters having a large size, he or she may intend to emphasize them like important descriptions or a caption in a handwritten page. For this reason, since the line width of large characters is changed to a thick line width, the important descriptions and caption can be easily visually confirmed, thus improving the readability of a handwritten page (handwritten document).

More specifically, the character recognition module 303 recognizes characters from a plurality of strokes indicated by time-series information (that is, a plurality of stroke data corresponding to a plurality of strokes) which is generated by the time-series information generator 302. For example, when the user makes an operation required to instruct to change a line width (for example, when he or she presses a predetermined button on the screen), or after an elapse of a predetermined period without any handwriting input operation, the character recognition module 303 recognizes characters from the plurality of strokes, thereby dividing the plurality of input strokes into blocks for respective characters.

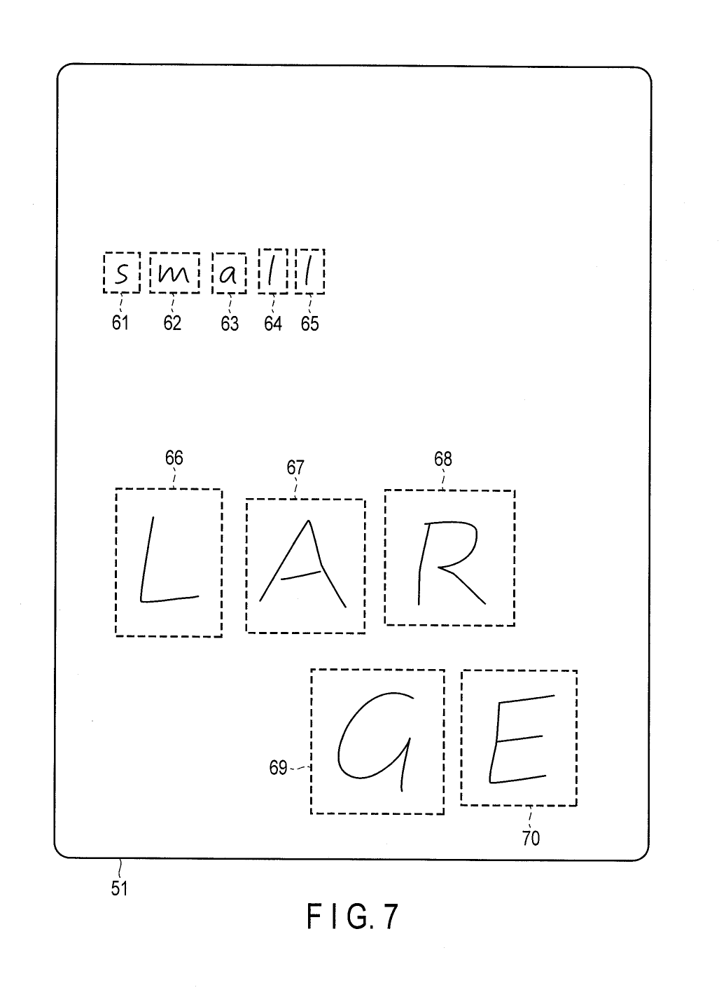

As shown in FIG. 7, one or more corresponding strokes are associated with each recognized character. That is, as a result of character recognition by the character recognition module 303, the plurality of strokes are divided into blocks 61 to 70 for respective characters.

The character recognition module 303 calculates, using, for example, one or more stroke data corresponding to one or more strokes (target strokes to be processed) of a plurality of stroke data, a first feature amount indicative of a shape of the one or more strokes. Then, the character recognition module 303 detects a character having a feature amount similar to the calculated first feature amount using character dictionary data stored in advance in a storage medium 402. This character dictionary data defines, for example, a plurality of characters and a plurality of feature amounts corresponding to these plurality of characters. Therefore, the character recognition module 303 recognizes a character having a second feature amount, a similarity to the calculated first feature amount of which is equal to or larger than a threshold, from the plurality of characters defined in the character dictionary data.

Note that the character recognition module 303 may detect a plurality of character candidates having feature amounts, similarities to the first feature amount of which are equal to or larger than the threshold, from the plurality of characters defined in the character dictionary data. In this case, the character recognition module 303 narrows down a most likely character (that having a high likelihood) with respect to the target strokes from the plurality of detected character candidates based on, for example, language dictionary data indicative of co-occurrence probabilities of words and characters and characters recognized from strokes adjacent to the target strokes (for example, right and left neighboring strokes of the target strokes). In this manner, the character recognition module 303 recognizes a character corresponding to the target strokes.

Then, the line width determination module 304 determines a line width (line thickness) of that character based on a size of the recognized character. The size of the recognized character is, for example, a size based on a rectangle (for example, a rectangle indicated by a dotted line in FIG. 7) which includes the one or more strokes which form that character. The size of the recognized character is expressed by, for example, a width and height of that rectangle, a larger value of the width and height, an area, or the like. The line width determination module 304 detects a line width according to the size of the recognized character using, for example, line width data stored in advance in the storage medium 402. The line width data may define line widths designated by the user for respective character sizes.

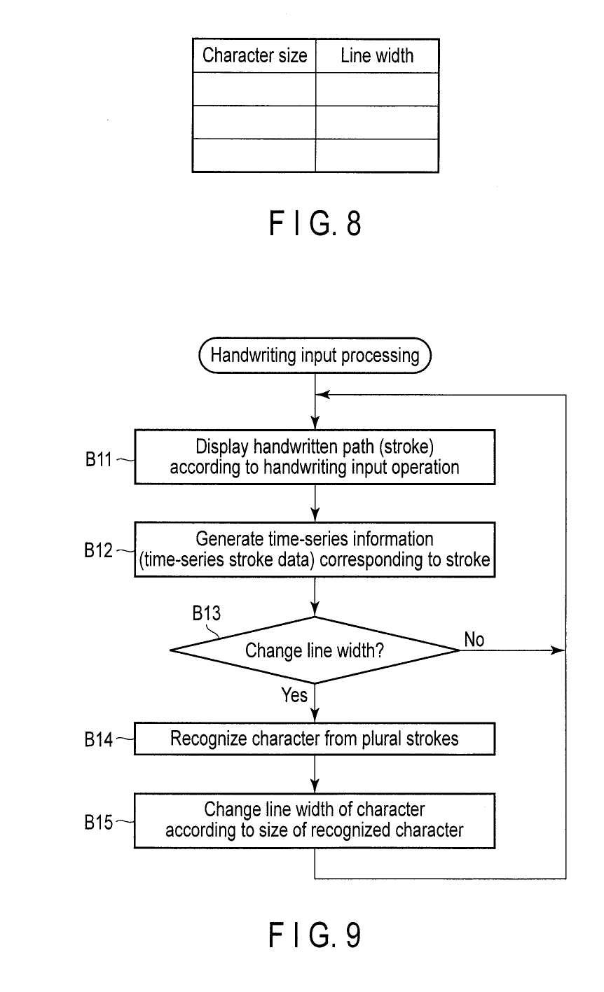

FIG. 8 shows a configuration example of the line width data. The line width data includes a plurality of entries corresponding to a plurality of character sizes. Each entry includes, for example, “character size” and “line width”. In an entry corresponding to a certain character size, “character size” indicates that character size (for example, in units of point). “Line width” indicates a thickness of a line (for example, in units of point) associated with a character having that character size.

More specifically, if the size of the recognized character is equal to or larger than a first threshold, the line width determination module 304 determines that one or more strokes corresponding to that character are displayed with a second line width thicker than a pre-set line width (first line width). Also, if the size of the recognized character is less than a second threshold, the line width determination module 304 determines that one or more strokes corresponding to that character are displayed with a third line width thinner than the first line width. Note that this second threshold is smaller than the first threshold. If the size of the recognized character is smaller than the first threshold and is equal to or larger than the second threshold, the line width determination module 304 determines that the line width of one or more strokes corresponding to that character is left unchanged (that is, that character is displayed with the first line width).

Note that the line width determination module 304 may control a line width so as to prevent a character from being illegible lettering due to an excessively thick line width. For example, when strokes having the increased line width overlap each other, the line width determination module 304 decreases the line width (it resets to the thin line width).

Furthermore, if the size of the recognized character is equal to or larger than a threshold, the line width determination module 304 may at least either display one or more strokes of that character to which an effect is applied or display the one or more strokes in a first color. Alternatively, if the size of the recognized character is smaller than the threshold, the line width determination module 304 may at least either display one or more strokes of that character to which an effect is applied or display the one or more strokes in a first color.

For example, if the size of the recognized character is equal to or larger than the threshold, the line width determination module 304 decides to subject a predetermined effect to one or more strokes corresponding to that character. For example, the line width determination module 304 decides to subject, to the strokes of the recognized characters, processing for converting the strokes to those (decorated character) as if they were drawn using a brush. For example, if the size of the recognized character is equal to or larger than the threshold, the line width determination module 304 decides to display one or more strokes corresponding to that character in a first color. Alternatively, if the size of the recognized character is smaller than the threshold, the line width determination module 304 decides to display one or more strokes corresponding to that character in the first color. As this first color, a color which makes the character stand out is set like that red is used on a handwritten document whose background color is white. The line width determination module 304 may temporarily store information (stroke attribute information) indicative of a line width, effect, color, or the like, which correspond to strokes indicated by time-series information, in the work memory 401.

The path display processor 301 displays character (one or more strokes to be processed) to have a line width determined by the line width determination module 304. Furthermore, the path display processor 301 applies a predetermined effect to a character (strokes) to be displayed in accordance with a request from the line width determination module 304. For example, the path display processor 301 subjects, to strokes of a character having a size equal to or larger than the threshold, processing for converting these strokes into those as if they were drawn using a brush, and displays the character that has subjected the processing. Alternatively, the path display processor 301 displays strokes of a character having a size equal to or larger than the threshold in the first color.

By changing a line width of strokes, subjecting an effect to the strokes, or changing a color of the strokes in this way, the user can recognize a large character (that having a size equal to or larger than the threshold) to be distinguished from a small character, thus improving the readability of a handwritten document.

The page storing processor 305 stores the generated time-series information (that temporarily stored in the work memory 401) and information (stroke attribute information temporarily stored in the work memory 401) indicative of line widths or the like corresponding to respective strokes in the storage medium 402 as handwritten document data. The storage medium 402 is, for example, a storage device in the tablet computer 10.

The page acquisition processor 306 reads arbitrary already stored handwritten document data from the storage medium 402. The read handwritten document data is sent to the handwritten document display processor 307. The handwritten document display processor 307 analyzes the handwritten document data, and displays paths of respective strokes indicated by the time-series information on the screen to have a line width, effect, or color indicated by the stroke attribute information as a handwritten document (handwritten page) based on the analysis result.

Note that the determination example of a line width for each character has been described. Alternatively, within a group such as a line or paragraph, a line width of characters included in that group may be determined. The line width determination module 304 determines a line width in consideration of not only a size of one recognized character, but also sizes of other characters in a group including that one character.

For example, assume that the character recognition module 303 recognizes a first character corresponding to one or more first strokes of a plurality of strokes input by handwriting, and recognizes a second character corresponding to one or more second strokes of the plurality of strokes. In this case, the line width determination module 304 determines whether a distance between the recognized first and second characters is equal to or shorter than a threshold (for example, the recognized first and second characters are within one line, one paragraph, or the like). For example, if the distance between a rectangle (first rectangle) including the first character and a rectangle (second rectangle) including the second character falls within a threshold range, the line width determination module 304 determines that these first and second characters are located within one line. More specifically, if an absolute difference between a Y coordinate of the upper end of the first rectangle and that of the upper end of the second rectangle is equal to or shorter than a threshold, and an absolute difference between a Y coordinate of the lower end of the first rectangle and that of the lower end of the second rectangle is equal to or shorter than the threshold, the line width determination module 304 determines that these first and second characters are located within one line. Also, if an absolute difference between an X coordinate of the upper end of the first rectangle and that of the upper end of the second rectangle is equal to or shorter than a threshold, and an absolute difference between an X coordinate of the lower end of the first rectangle and that of the lower end of the second rectangle is equal to or shorter than the threshold, the line width determination module 304 determines that these first and second characters are located within one column.

If the distance between the first and second characters is equal to or shorter than the threshold, the line width determination module 304 decides to display the one or more first strokes and the one or more second strokes with the same line width. For example, the line width determination module 304 decides to display the one or more first strokes and the one or more second strokes with a line width determined using at least one of a line width associated with the size of the first character and that associated with the size of the second character.

Note that if the distance between the first and second characters is equal to or shorter than a first threshold, and a difference between sizes of the first and second characters is equal to or smaller than a second threshold (for example, if the difference is equal to or smaller than a 20% of one character size), the line width determination module 304 may set the same line width as those of the first and second characters. For example, the line width determination module 304 sets an average of a line width corresponding to the size of the first character and that corresponding to the size of the second character as the line widths of the first and second characters.

Likewise, the line width determination module 304 can set the same line width for a plurality of characters handwritten in a single line or single paragraph. Thus, the line width determination module 304 can control the line widths of characters from varying in a character group such as a single line or paragraph. Also, when there are a plurality of handwritten pages, the line width determination module 304 can set the same line width for a plurality of characters handwritten in the plurality of pages included in a single group. For example, a tag may be added to the plurality of pages to indicate that these pages are included in the single group.

The line width determination module 304 may subject a clustering processing to a plurality of recognized characters in a handwritten document based on sizes of characters. The line width determination module 304 can set appropriate line widths for respective clusters for characters which belong to a plurality of clusters based on the clustering result.

Note that the character recognition module 303 may often fail to appropriately recognize strokes (target strokes) to be processed as a character. For example, since handwritten characters may have different shapes and stroke orders for respective users, a detection failure of a corresponding character or detection of a wrong character for the target strokes may occur in character recognition using the character dictionary data. In this case, the line width determination module 304 sets a line width set for a character of neighboring strokes for strokes which are failed to be recognized as a character. Alternatively, the character recognition module 303 may determine that a plurality of strokes on a handwritten document cannot be divided into appropriate strokes, and redo character recognition of the plurality of strokes.

Furthermore, a figure is often handwritten on a handwritten document. The line width determination module 304 sets a line width set for a character in the neighborhood of that handwritten figure for a line width of the handwritten figure. In this case, the line width determination module 304 controls the line width so that the handwritten figure displayed to have the set line width does not overlap handwritten characters and the like. Note that the line width determination module 304 may not change the line width of the handwritten figure (it may maintain the line with at the time of handwriting input processing).

Note that the processing for a horizontally written document in which a plurality of characters are handwritten in the horizontal direction has been described above. Also, the aforementioned processing can be applied to a vertically written document in which a plurality of characters are handwritten in the vertical direction. In this case, the line width determination module 304 determines a line width of characters included in a group such as a vertically written line or paragraph. The path display processor 301 displays characters (strokes) in the vertically written line or paragraph with the line width determined by the line width determination module 304.

An example of the procedure of handwriting input processing executed by the digital notebook application 202 will be described below with reference to FIG. 9.

The path display processor 301 displays a path (stroke) of a movement of the pen 100 or the like by a handwriting input operation on the display 17A (block B11). The time-series information generator 302 generates the aforementioned time-series information (a plurality of stroke data arranged in a time-series order) based on a coordinate sequence corresponding to the path by the handwriting input operation, and temporarily stores that time-series information in the work memory 401 (block B12).

Next, the character recognition module 303 determines whether a line width of the path (stroke) displayed on the display 17A is to be changed (block B13). For example, if the user makes an operation to instruct to change the line width (if he or she presses a predetermined button on the screen) or if a predetermined period has elapsed without any handwriting input operation, the character recognition module 303 determines that the line width is to be changed. If the line width is not changed (NO in block B13), the process returns to block B11 to continue the processing for a handwriting input operation.

If the line width is to be changed (YES in block B13), the character recognition module 303 recognizes a plurality of characters from a plurality of strokes (block B14). For example, the character recognition module 303 converts respective handwritten characters into character codes. With this character recognition, a plurality of strokes are divided into blocks for respective characters.

Next, the line width determination module 304 changes a line width (line thickness) of a character according to a size of the recognized character (block B15). Correspondence between character sizes and line widths are defined by, for example, line width data stored in the storage medium 402. The path display processor 301 displays strokes which form that character on the display 17A with the changed line width.

Note that a handwritten document can also be converted into a formed document using the character recognition result of the character recognition module 303. For example, the character recognition module 303 subjects character recognition to a plurality of strokes included in a handwritten document to convert them into character codes corresponding to recognized characters. Each converted character code is associated with a font which has the same size as that of a handwritten character before conversion, and has a line width suited to that size. Thus, the character recognition module 303 can generate formed document data, which can be handled by word processing software such as Word® from handwritten document data.

As describe above, according to this embodiment, a character input by handwriting can be displayed with an appropriate line width. The path display processor 301 displays a plurality of strokes input by handwriting on the screen to have a first line width. The time-series information generator 302 generates a plurality of stroke data corresponding to the plurality of strokes. The character recognition module 303 recognizes, using the plurality of generated stroke data, a character corresponding to one or more strokes of the plurality of strokes. Then, the line width determination module 304 determines a line width according to a size of the recognized character, and the path display processor 301 displays the one or more strokes with the determined line width.

Thus, when the user makes a handwriting input operation on various devices which function as a digital notebook, a character can be automatically displayed with an appropriate thickness without requiring the user to make an operation for changing the thickness (line width of a path) of a pen. Thus, the viewability (readability) of a handwritten page can be improved.

Note that the sequence of the handwriting input processing of this embodiment can be fully executed by software. For this reason, by only installing a program required to execute the sequence of the handwriting input processing in a normal computer via a computer-readable storage medium which stores that program, and executing the installed program, the same effects as in this embodiment can be easily realized.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electronic apparatus comprising:
a display processor configured to display a plurality of strokes with a line width, the plurality of strokes being input by handwriting; and
a generator configured to generate stroke data corresponding to the plurality of strokes
wherein a first line width of one or more strokes of the plurality of strokes is determined by using a size of a character corresponding to the one or more strokes.

2. The apparatus of claim 1, wherein the display processor is configured to display the one or more strokes with a second line width thicker than the first line width if the size of the character is equal to or larger than a first threshold.

3. The apparatus of claim 2, wherein the display processor is configured to display the one or more strokes with a third line width thinner than the first line width if the size of the character is smaller than a second threshold.

4. The apparatus of claim 1, wherein
the display processor is further configured to display one or more first strokes of the plurality of strokes and one or more second strokes of the plurality of strokes with a same line width if a distance between a first character corresponding to the one or more strokes and a second character corresponding to the one or more strokes is equal to or shorter than a first threshold.

5. The apparatus of claim 4, wherein the same line width is determined using at least one of a line width associated with a size of the first character and a line width associated with a size of the second character.

6. The apparatus of claim 4, wherein the display processor is further configured to display the one or more first strokes and the one or more second strokes with the same line width if the distance between the first character and the second character is equal to or shorter than the first threshold and a difference between a size of the first character and a size of the second character is equal to or smaller than a second threshold.

7. The apparatus of claim 1, wherein if the size of the character is equal to or larger than a threshold, the display processor is configured to at least either display the one or more strokes to which an effect is applied or display the one or more strokes in a first color.

8. The apparatus of claim 1, wherein if the size of the character is smaller than a threshold, the display processor is configured to at least either display the one or more strokes to which an effect is applied or display the one or more strokes in a first color.

9. The apparatus of claim 1, further comprising a touch screen display,
wherein the plurality of strokes are input using the touch screen display.

10. A method comprising:
displaying a plurality of strokes with a line width, the plurality of strokes being input by handwriting; and
generating stroke data corresponding to the plurality of strokes
wherein a first line width of one or more strokes of the plurality of strokes is determined by using a size of a character corresponding to the one or more strokes.

11. A computer-readable, non-transitory storage medium having stored thereon a program which is executable by a computer, the program controlling the computer to execute functions of:
displaying a plurality of strokes with a line width, the plurality of strokes being input by handwriting; and
generating stroke data corresponding to the plurality of strokes
wherein a first line width of one or more strokes of the plurality of strokes is determined by using a size of a character corresponding to the one or more strokes.

12. The apparatus of claim 1, wherein the size is determined by using a size of a character which is recognized by using one or more stroke data items corresponding to the one or more strokes.

13. The method of claim 10, wherein the size is determined by using a size of a character which is recognized by using one or more stroke data items corresponding to the one or more strokes.

14. The method of claim 10, wherein the displaying comprises displaying the one or more strokes with a second line width thicker than the first line width if the size of the character is equal to or larger than a first threshold.

15. The method of claim 14, wherein the displaying comprises displaying the one or more strokes with a third line width thinner than the first line width if the size of the character is smaller than a second threshold.

16. The method of claim 10, wherein the displaying further comprises displaying one or more first strokes of the plurality of strokes and one or more second strokes of the plurality of strokes with a same line width if a distance between a first character corresponding to the one or more strokes and a second character corresponding to the one or more strokes is equal to or shorter than a first threshold.

17. The method of claim 16, wherein the same line width is determined using at least one of a line width associated with a size of the first character and a line width associated with a size of the second character.

18. The method of claim 16, wherein the displaying further comprises displaying the one or more first strokes and the one or more second strokes with the same line width if the distance between the first character and the second character is equal to or shorter than the first threshold and a difference between a size of the first character and a size of the second character is equal to or smaller than a second threshold.

19. The method of claim 10, wherein if the size of the character is equal to or larger than a threshold, the displaying comprises at least either displaying the one or more strokes to which an effect is applied or displaying the one or more strokes in a first color.

20. The method of claim 10, wherein if the size of the character is smaller than a threshold, the displaying comprises at least either displaying the one or more strokes to which an effect is applied or displaying the one or more strokes in a first color.

21. The method of claim 10, wherein the plurality of strokes are input using a touch screen display.

22. The storage medium of claim 11, wherein the size is determined by using a size of a character which is recognized by using one or more stroke data items corresponding to the one or more strokes.

23. The storage medium of claim 11, wherein the displaying comprises displaying the one or more strokes with a second line width thicker than the first line width if the size of the character is equal to or larger than a first threshold.

24. The storage medium of claim 23, wherein the displaying comprises displaying the one or more strokes with a third line width thinner than the first line width if the size of the character is smaller than a second threshold.

25. The storage medium of claim 11, wherein the displaying further comprises displaying one or more first strokes of the plurality of strokes and one or more second strokes of the plurality of strokes with a same line width if a distance between a first character corresponding to the one or more strokes and a second character corresponding to the one or more strokes is equal to or shorter than a first threshold.

26. The storage medium of claim 25, wherein the same line width is determined using at least one of a line width associated with a size of the first character and a line width associated with a size of the second character.

27. The storage medium of claim 25, wherein the displaying further comprises displaying the one or more first strokes and the one or more second strokes with the same line width if the distance between the first character and the second character is equal to or shorter than the first threshold and a difference between a size of the first character and a size of the second character is equal to or smaller than a second threshold.

28. The storage medium of claim 11, wherein if the size of the character is equal to or larger than a threshold, the displaying comprises at least either display the one or more strokes to which an effect is applied or display the one or more strokes in a first color.

29. The storage medium of claim 11, wherein if the size of the character is smaller than a threshold, the displaying comprises at least either displaying the one or more strokes to which an effect is applied or displaying the one or more strokes in a first color.

30. The storage medium of claim 11, wherein the plurality of strokes are input using a touch screen display.
